(19) United States
(12) Patent Application Publication
(10) Pub. No.: US 2025/0101638 A1
(43) Pub. Date: Mar. 27, 2025

(54) ARTIFICIAL HAIR FIBERS AND HAIRPIECE PRODUCT

(71) Applicant: Denka Company Limited, Chuo-ku, Tokyo (JP)

(72) Inventors: Takashi MURAOKA, Chuo-ku, Tokyo (JP); Yuki SAGARA, Chuo-ku, Tokyo (JP)

(73) Assignee: Denka Company Limited, Chuo-ku, Tokyo (JP)

(21) Appl. No.: 18/832,473

(22) PCT Filed: Oct. 25, 2022
(86) PCT No.: PCT/JP2022/039753

§ 371 Date: Jul. 23, 2024

(30) Foreign Application Priority Data
Jan. 25, 2022 (JP) 2022-009502

(51) Int. Cl. D01F 6/48; A41G 3/00; C08L 27/06; D01F 6/10; D01F 6/16; D01F 6/42

(52) U.S. Cl. CPC D01F 6/48; A41G 3/0083; C08L 27/06; D01F 6/10; D01F 6/16; D01F 6/42; C08L 2203/12; C08L 2205/03; D10B 2503/08

(57) ABSTRACT

A fiber for artificial hair having a plurality of single fibers, in which the single fibers each contain (A) a vinyl chloride polymer, (B) an aromatic vinyl polymer, and (C) a (meth)acrylic acid-based polymer, a content of the component (B) is more than 0% by mass and 50% by mass or less on the basis of the total amount of the component (A) and the component (B), a content of the component (C) is more than 0% by mass and 8% by mass or less on the basis of the total amount of the component (A) and the component (B), and a coefficient of variation of fineness of the single fibers is 35 or less.

### TECHNICAL FIELD

The present invention relates to a fiber for artificial hair, a hair decoration product, and the like.

### BACKGROUND ART

Vinyl chloride polymer fibers obtained by spinning a vinyl chloride polymer are excellent in flexibility, and thus are often used as fibers for artificial hair constituting hair decoration products. However, since the vinyl chloride polymer has a large specific gravity, the vinyl chloride polymer fibers are not suitable for styles requiring volume in artificial hair use applications. In order to reduce the specific gravity of the vinyl chloride polymer fibers, a means for blending an aromatic vinyl polymer having a smaller specific gravity than that of the vinyl chloride polymer has been proposed (see, for example, Patent Literatures 1 and 2 below).

### CITATION LIST

### Patent Literature

Patent Literature 1: International Publication WO 2006/038447
Patent Literature 2: International Publication WO 2019/181868

### SUMMARY OF INVENTION

### Technical Problem

It is demanded for the fiber for artificial hair to suppress the breakage of the fiber (yarn breakage) at the time of performing melt-spinning or the like and to be excellent in spinnability. Furthermore, from the viewpoint of preventing a user from feeling uncomfortable, the fiber for artificial hair is required to be excellent in combability (ease of combing) of a fiber bundle.

An object of an aspect of the present invention is to provide a fiber for artificial hair having excellent spinnability and combability. An object of another aspect of the present invention is to provide a hair decoration product using the fiber for artificial hair.

### Solution to Problem

The present disclosure relates to the following [1] to [8] and the like in some aspects.

[1] A fiber for artificial hair having a plurality of single fibers, in which the single fibers each contain (A) a vinyl chloride polymer, (B) an aromatic vinyl polymer, and (C) a (meth)acrylic acid-based polymer, a content of the component (B) is more than 0% by mass and 50% by mass or less on the basis of the total amount of the component (A) and the component (B), a content of the component (C) is more than 0% by mass and 8% by mass or less on the basis of the total amount of the component (A) and the component (B), and a coefficient of variation of fineness of the single fibers is 35 or less.

[2] The fiber for artificial hair described in [1], in which the component (B) has styrene and acrylonitrile as monomer units.

[3] The fiber for artificial hair described in [1] or [2], in which a weight average molecular weight of the component (C) is 200000 to 10000000.

[4] The fiber for artificial hair described in any one of [1] to [3], in which the component (C) has methyl (meth)acrylate as a monomer unit.

[5] The fiber for artificial hair described in [4], in which in the component (C), a content of the monomer unit of methyl (meth)acrylate is 60 to 90% by mass, and a content of the monomer unit of butyl (meth)acrylate is 10 to 40% by mass.

[6] The fiber for artificial hair described in [4] or [5], in which a weight average molecular weight of the component (C) is 500000 to 5000000.

[7] The fiber for artificial hair described in any one of [4] to [6], in which the content of the component (C) is 0.5 to 1.5% by mass on the basis of the total amount of the component (A) and the component (B).

[8] A hair decoration product having the fiber for artificial hair described in any one of [1] to [7].

### Advantageous Effects of Invention

According to an aspect of the present invention, it is possible to provide a fiber for artificial hair having excellent spinnability and combability. According to another aspect of the present invention, it is possible to provide a hair decoration product using the fiber for artificial hair. According to still another aspect of the present invention, it is possible to provide an use of a fiber to artificial hair or its production. According to still another aspect of the present invention, it is possible to provide an use of a fiber to a hair decoration product or its production.

### DESCRIPTION OF EMBODIMENTS

Hereinafter, embodiments for carrying out the present invention will be described in detail. Note that, the present invention is not limited to embodiments which will be described below.

In the numerical ranges that are described stepwise in the present specification, the upper limit value or the lower limit value of the numerical range of a certain stage can be arbitrarily combined with the upper limit value or the lower limit value of the numerical range of another stage. In the numerical ranges that are described in the present specification, the upper limit value or the lower limit value of the numerical range may be replaced with the value shown in Examples. Materials listed as examples in the present specification can be used singly or in combinations of two or more kinds, unless otherwise specifically indicated. In a case where a plurality of substances corresponding to each component in a composition is present, unless otherwise specifically indicated, the content of each component in the composition means the total amount of the plurality of substances present in the composition. The term “(meth)acrylic acid” means at least one of acrylic acid and methacrylic acid corresponding thereto. The same also applies to other similar expressions such as “(meth)acrylonitrile”.

The fiber for artificial hair of the present embodiment has a plurality of single fibers (hereinafter, referred to as “single fibers F”). The single fibers F each contain (A) a vinyl chloride polymer (hereinafter, sometimes referred to as “component (A)”), (B) an aromatic vinyl polymer (hereinafter, sometimes referred to as “component (B)”), and (C) a (meth)acrylic acid-based polymer (hereinafter, sometimes referred to as “component (C)”). The content of the component (B) is more than 0% by mass and 50% by mass or less on the basis of the total amount of the component (A) and the component (B), and the content of the component (C) is more than 0% by mass and 8% by mass or less on the basis of the total amount of the component (A) and the component (B). In the fiber for artificial hair of the present embodiment, a coefficient of variation of fineness (single fiber fineness) of the single fibers F is 35 or less.

The fiber for artificial hair of the present embodiment has excellent spinnability, and for example, in the evaluation method described in Examples below, the yarn breakage can be suppressed to 3 times or less. Furthermore, the fiber for artificial hair of the present embodiment has excellent combability, and for example, in the evaluation method described in Examples below, the resistive force can be reduced to 300 gf or less (preferably 250 gf or less).

Incidentally, the present inventors have conceived of improving voluminousness (specific volume) by subjecting a fiber for artificial hair to a gear processing treatment so as to crimp the fiber for artificial hair when a hair decoration product is obtained using the fiber for artificial hair. However, in the case of using a fiber for artificial hair containing an aromatic vinyl polymer, there is a problem in that voluminousness may not be sufficiently improved, and styles that can be created are limited. On the other hand, according to an embodiment of the fiber for artificial hair of the present embodiment, artificial hair excellent in voluminousness (specific volume) can be obtained by subjecting the fiber for artificial hair to a gear processing treatment, and for example, in the evaluation method described in Examples below, by subjecting the fiber for artificial hair to a gear processing treatment (depth of the groove of the gear waveform: 2.5 mm, surface temperature: 90° C., processing rate: 1.0 m/min), a specific volume of 6.0 cc/g or more (preferably 8.0 cc/g or more) can be obtained. Furthermore, although combability may be reduced when the fiber is crimped, according to an embodiment of the fiber for artificial hair of the present embodiment, excellent combability can be obtained while obtaining excellent voluminousness.

The gear processing treatment is a treatment of passing the fiber between two meshing high-temperature gears to perform crimping. In the gear processing treatment for the fiber for artificial hair, the material of the gear, the gear waveform, the fraction of the gear, and the like are not particularly limited. The wave shape of the crimp can change depending on the fiber material, the fineness, pressure conditions between the gears, and the like, but in the present embodiment, the wave shape of the crimp can be controlled by the depth of the groove of the gear waveform, the surface temperature of the gear, the processing rate, and the like. There are no particular restrictions on these processing conditions, but the depth of the groove of the gear waveform may be 0.2 to 6 mm or 0.5 to 5 mm, the surface temperature of the gear may be 50 to 110° C. or 60 to 100° C., and the processing rate may be 0.5 to 10 m/min or 1.0 to 8.0 m/min.

The fiber for artificial hair of the present embodiment is a group of fibers for artificial hair having a plurality of single fibers F, and may be, for example, a group of fibers for artificial hair having 100 or more single fibers F. The fiber for artificial hair of the present embodiment may be a fiber bundle for artificial hair. The fiber for artificial hair of the present embodiment may be used as artificial hair, and may be used in order to obtain artificial hair. The single fibers F in the fiber for artificial hair of the present embodiment may be fibers obtained after a stretching treatment, and may be non-stretched fibers.

In the fiber for artificial hair of the present embodiment, a coefficient of variation of fineness of the plurality of single fibers F is 35 or less. When the coefficient of variation of fineness of the single fibers F is 35 or less, excellent combability is obtained. It is presumed that, when the coefficient of variation of fineness is small, since it is difficult for yarns having a low fineness to be included, excellent combability is obtained. However, the factors that result in excellent combability are not limited to the above contents. The coefficient of variation of fineness of the single fibers F may be the coefficient of variation of fineness of 100 single fibers F, and may be calculated using the average value and standard deviation of fineness of 100 single fibers F. The single fibers F to be evaluated for the coefficient of variation may be single fibers obtained by subjecting a resin composition to melt-spinning, stretching treatment, and a heating treatment, as described in Examples below. The coefficient of variation of fineness of the single fibers F can be adjusted by the content of the component (B), the weight average molecular weight and content of the component (C), the type and content of the monomer unit in the component (C), and the like. For example, in a case where the content of the component (B), the content of the component (C), or the content of the monomer unit of methyl (meth)acrylate in the component (C) is large, a case where the weight average molecular weight of the component (C) is large, or a case where the content of the monomer unit of butyl (meth)acrylate in the component (C) is small, there is a tendency that the coefficient of variation decreases.

From the viewpoint of easily obtaining excellent combability, the coefficient of variation of fineness of the single fibers F may be 30 or less, 25 or less, 24 or less, 20 or less, 18 or less, 16 or less, 15 or less, 14 or less, 12 or less, or 10 or less. The coefficient of variation of fineness of the single fibers F may be 0 or more, more than 0, 1 or more, 3 or more, 5 or more, 8 or more, 10 or more, 12 or more, 14 or more, 15 or more, 16 or more, 18 or more, 20 or more, 24 or more, 25 or more, or 30 or more. From these viewpoints, the coefficient of variation of fineness of the single fibers F may be 0 to 30, more than 0 and 30 or less, 1 to 30, 5 to 30, 5 to 20, 5 to 15, or 5 to 12.

The average value of fineness (unit: dtex) of the single fibers F may be in the following range. The average value may be 10 or more, 20 or more, 30 or more, 40 or more, or 50 or more. The average value may be 100 or less, 90 or less, 80 or less, 70 or less, 60 or less, or 50 or less. From these viewpoints, the average value may be 10 to 100, 30 to 80, or 40 to 60. The average value of fineness of the single fibers F may be the average value of 100 single fibers F.

The standard deviation of fineness (unit: dtex) of the single fibers F may be in the following range. The standard deviation may be 0 or more, more than 0, 1 or more, 3 or more, 5 or more, 6 or more, 7 or more, 8 or more, 9 or more, 10 or more, 12 or more, or 15 or more. The standard deviation may be 15 or less, 12 or less, 10 or less, 9 or less, 8 or less, 7 or less, 6 or less, or 5 or less. From these viewpoints, the standard deviation may be 0 to 15, more than 0 and 15 or less, 1 to 15, or 1 to 10. The standard deviation of fineness of the single fibers F may be the standard deviation of 100 single fibers F.

The single fibers F each contain, as the component (A), a vinyl chloride polymer (excluding the component (C); for example, a vinyl chloride-based resin). The “vinyl chloride polymer” is a polymer having vinyl chloride as a monomer unit (a polymer having a structural unit derived from vinyl chloride). The component (A) does not have a (meth)acrylic acid-based compound (a compound having a (meth)acryloyl group) as a monomer unit. The component (A) may be a homopolymer of vinyl chloride, and may be a copolymer of vinyl chloride. The copolymer of vinyl chloride is a polymer of vinyl chloride and another compound (compound other than vinyl chloride).

Examples of the copolymer of vinyl chloride include copolymers of vinyl chloride and vinyl esters such as a vinyl chloride-vinyl acetate copolymer and a vinyl chloride-vinyl propionate copolymer; copolymers of vinyl chloride and olefins such as a vinyl chloride-ethylene copolymer and a vinyl chloride-propylene copolymer; and a vinyl chloride-(meth)acrylonitrile copolymer.

From the viewpoint of easily obtaining excellent spinnability, combability, and voluminousness, the component (A) may include at least one selected from the group consisting of a homopolymer of vinyl chloride, a vinyl chloride-ethylene copolymer, and a vinyl chloride-vinyl acetate copolymer, and may include a homopolymer of vinyl chloride.

The component (A) can be produced by emulsion polymerization, bulk polymerization, suspension polymerization, or the like. The component (A) may be a polymer produced by suspension polymerization from the viewpoint of the initial colorability of the fiber, or the like.

The content of the component (A) may be in the following range on the basis of the total amount of the component (A) and the component (B). From the viewpoint of easily obtaining excellent combability and voluminousness, the content of the component (A) may be 99% by mass or less, 98% by mass or less, 96% by mass or less, 95% by mass or less, less than 95% by mass, 90% by mass or less, 85% by mass or less, 83% by mass or less, 80% by mass or less, 75% by mass or less, 70% by mass or less, 65% by mass or less, 60% by mass or less, or 55% by mass or less. From the viewpoint of easily obtaining excellent spinnability, the content of the component (A) may be 50% by mass or more, more than 50% by mass, 55% by mass or more, 60% by mass or more, 65% by mass or more, 70% by mass or more, 75% by mass or more, 80% by mass or more, 83% by mass or more, 85% by mass or more, 90% by mass or more, 95% by mass or more, more than 95% by mass, or 96% by mass or more. From these viewpoints, the content of the component (A) may be 50% by mass or more and less than 100% by mass, 50 to 99% by mass, 50 to 98% by mass, 50 to 96% by mass, 50 to 95% by mass, 60 to 96% by mass, 65 to 96% by mass, 70 to 96% by mass, 60 to 95% by mass, 65 to 90% by mass, or 65 to 80% by mass.

The single fibers F each contain, as the component (B), an aromatic vinyl polymer (excluding the component (C); for example, an aromatic vinyl-based resin). The “aromatic vinyl polymer” is a polymer having an aromatic vinyl compound as a monomer unit (a polymer having a structural unit derived from an aromatic vinyl compound). The component (B) does not have a (meth)acrylic acid-based compound (a compound having a (meth)acryloyl group) as a monomer unit. Examples of the aromatic vinyl compound include a styrene-based compound, vinyltoluene, vinylnaphthalene, and vinylanthracene.

The styrene-based compound may include at least one selected from the group consisting of styrene and a styrene derivative. Examples of the styrene derivative include α-methylstyrene, o-methylstyrene, m-methylstyrene, p-methylstyrene, t-butylstyrene, and chlorostyrene. From the viewpoint of easily obtaining excellent spinnability, combability, and voluminousness, the styrene-based compound may include styrene.

The component (B) may be a homopolymer of an aromatic vinyl compound, or may be a copolymer of an aromatic vinyl compound (for example, an aromatic vinyl-based copolymer resin). The aromatic vinyl copolymer may be a copolymer having a plurality of kinds of aromatic vinyl compounds as monomer units, or may be a copolymer having an aromatic vinyl compound and a compound different from the aromatic vinyl compound as monomer units.

Examples of the compound different from the aromatic vinyl compound include (meth)acrylonitrile and maleic anhydride. As the component (B), a polymer not having vinyl chloride as a monomer unit can be used, and a polymer not having a halogen-containing compound as a monomer unit may be used.

From the viewpoint of easily obtaining excellent spinnability, combability, and voluminousness, the component (B) may have a styrene-based compound and (meth)acrylonitrile as monomer units (may have a monomer unit of a styrene-based compound and at least one selected from the group consisting of a monomer unit of acrylonitrile and a monomer unit of methacrylonitrile), may have styrene and (meth)acrylonitrile as monomer units, or may have styrene and acrylonitrile as monomer units.

The content of the monomer unit of the styrene-based compound may be in the following range on the basis of the entire component (B) or the total amount of the monomer unit of the styrene-based compound and the monomer unit of the (meth)acrylonitrile (the total amount of the monomer unit of the styrene-based compound, the monomer unit of the acrylonitrile, and the monomer unit of the methacrylonitrile; the same applies hereinafter). From the viewpoint of easily obtaining excellent voluminousness, the content of the monomer unit of the styrene-based compound may be 50% by mass or more, more than 50% by mass, 60% by mass or more, more than 60% by mass, 64% by mass or more, 65% by mass or more, 68% by mass or more, 69% by mass or more, more than 69% by mass, 70% by mass or more, more than 70% by mass, 74% by mass or more, 75% by mass or more, 80% by mass or more, 82% by mass or more, 85% by mass or more, more than 85% by mass, or 86% by mass or more. From the viewpoint of easily obtaining excellent spinnability, the content of the monomer unit of the styrene-based compound may be less than 100% by mass, 95% by mass or less, 90% by mass or less, 88% by mass or less, less than 88% by mass, 86% by mass or less, 85% by mass or less, less than 85% by mass, 82% by mass or less, 80% by mass or less, 75% by mass or less, 74% by mass or less, 70% by mass or less, less than 70% by mass, 69% by mass or less, less than 69% by mass, 68% by mass or less, 65% by mass or less, or 64% by mass or less. From these viewpoints, the content of the monomer unit of the styrene-based compound may be 50% by mass or more and less than 100% by mass, 60 to 95% by mass, 68 to 90% by mass, 68 to 86% by mass, 68 to 82% by mass, 68 to 75% by mass, 68 to 70% by mass, 70 to 90% by mass, 75 to 90% by mass, 82 to 90% by mass, 86 to 90% by mass, 70 to 86% by mass, 70 to 82% by mass, 70 to 75% by mass, 75 to 86% by mass, 82 to 86% by mass, 75 to 82% by mass, 50 to 82% by mass, 60 to 82% by mass, 82 to 95% by mass, 74 to 88% by mass, or 74% by mass or more and less than 88% by mass.

The content of the monomer unit of the (meth)acrylonitrile (the total amount of the monomer unit of the acrylonitrile and the monomer unit of the methacrylonitrile; the same applies hereinafter) may be in the following range on the basis of the entire component (B) or the total amount of the monomer unit of the styrene-based compound and the monomer unit of the (meth)acrylonitrile. From the viewpoint of easily obtaining excellent spinnability, the content of the monomer unit of the (meth)acrylonitrile may be more than 0% by mass, 5% by mass or more, 10% by mass or more, 12% by mass or more, more than 12% by mass, 14% by mass or more, 15% by mass or more, more than 15% by mass, 18% by mass or more, 20% by mass or more, 25% by mass or more, 26% by mass or more, 30% by mass or more, more than 30% by mass, 31% by mass or more, more than 31% by mass, 32% by mass or more, 35% by mass or more, or 36% by mass or more. From the viewpoint of easily obtaining excellent voluminousness and the viewpoint of suppressing the color tone of the fiber for artificial hair, the content of the monomer unit of the (meth)acrylonitrile may be 50% by mass or less, less than 50% by mass, 40% by mass or less, less than 40% by mass, 36% by mass or less, 35% by mass or less, 32% by mass or less, 31% by mass or less, less than 31% by mass, 30% by mass or less, less than 30% by mass, 26% by mass or less, 25% by mass or less, 20% by mass or less, 18% by mass or less, 15% by mass or less, less than 15% by mass, or 14% by mass or less. From these viewpoints, the content of the monomer unit of the (meth)acrylonitrile may be more than 0% by mass and 50% by mass or less, 5 to 40% by mass, 10 to 32% by mass, 14 to 32% by mass, 18 to 32% by mass, 25 to 32% by mass, 30 to 32% by mass, 10 to 30% by mass, 10 to 25% by mass, 10 to 18% by mass, 10 to 14% by mass, 14 to 30% by mass, 18 to 30% by mass, 25 to 30% by mass, 14 to 25% by mass, 14 to 18% by mass, 18 to 25% by mass, 18 to 50% by mass, 18 to 40% by mass, 5 to 18% by mass, 12 to 26% by mass, or more than 12% by mass and 26% by mass or less.

The combination of the content of the monomer unit of the styrene-based compound and the content of the monomer unit of the (meth)acrylonitrile is arbitrary, and each of the content of the monomer unit of the styrene-based compound and the content of the monomer unit of the (meth)acrylonitrile may be in each of the above ranges. For example, the component (B) may be an embodiment in which the content of the monomer unit of the styrene-based compound is 50 to 95% by mass and the content of the monomer unit of the (meth)acrylonitrile is 5 to 50% by mass, or an embodiment in which the content of the monomer unit of the styrene-based compound is 60 to 90% by mass and the content of the monomer unit of the (meth)acrylonitrile is 10 to 40% by mass, on the basis of the entire component (B) or the total amount of the monomer unit of the styrene-based compound and the monomer unit of the (meth)acrylonitrile.

From the viewpoint of easily obtaining excellent spinnability, combability, and voluminousness, the total amount of the monomer unit of the styrene-based compound and the monomer unit of the (meth)acrylonitrile in the component (B) may be 50% by mass or more, more than 50% by mass, 60% by mass or more, 70% by mass or more, 80% by mass or more, 90% by mass or more, 92% by mass or more, 95% by mass or more, 96% by mass or more, 98% by mass or more, 99% by mass or more, 99.5% by mass or more, or substantially 100% by mass, on the basis of the entire component (B).

The content of the component (B) is more than 0% by mass and 50% by mass or less on the basis of the total amount of the component (A) and the component (B). When the content of the component (B) is 50% by mass or less, excellent spinnability is obtained. It is presumed that, in the case of using the above-described specific amount of the component (B), since the mixing (compatibility) of the component (A) and the component (B) becomes favorable and the dispersibility of the component (A) and the component (B) is improved, discharge from a nozzle hole in spinning becomes uniform so that excellent spinnability is obtained. However, the factors that result in excellent spinnability are not limited to the above contents.

The content of the component (B) may be in the following range on the basis of the total amount of the component (A) and the component (B). From the viewpoint of easily obtaining excellent combability and voluminousness, the content of the component (B) may be 1% by mass or more, 2% by mass or more, 4% by mass or more, 5% by mass or more, more than 5% by mass, 10% by mass or more, 15% by mass or more, 17% by mass or more, 20% by mass or more, 25% by mass or more, 30% by mass or more, 35% by mass or more, 40% by mass or more, or 45% by mass or more. From the viewpoint of easily obtaining excellent spinnability, the content of the component (B) may be less than 50% by mass, 45% by mass or less, 40% by mass or less, 35% by mass or less, 30% by mass or less, 25% by mass or less, 20% by mass or less, 17% by mass or less, 15% by mass or less, 10% by mass or less, 5% by mass or less, less than 5% by mass, or 4% by mass or less. From these viewpoints, the content of the component (B) may be 1 to 50% by mass, 2 to 50% by mass, 4 to 50% by mass, 5 to 50% by mass, 4 to 40% by mass, 4 to 35% by mass, 4 to 30% by mass, 5 to 40% by mass, 10 to 35% by mass, or 20 to 35% by mass.

The combination of the content of the component (A) and the content of the component (B) is arbitrary, and each of the content of the component (A) and the content of the component (B) may be in each of the above ranges. For example, the single fibers F may be an embodiment in which the content of the component (A) is 50 to 99% by mass and the content of the component (B) is 1 to 50% by mass, an embodiment in which the content of the component (A) is 60 to 95% by mass and the content of the component (B) is 5 to 40% by mass, or an embodiment in which the content of the component (A) is 65 to 90% by mass and the content of the component (B) is 10 to 35% by mass, on the basis of the total amount of the component (A) and the component (B).

The total amount of the component (A) and the component (B) may be in the following range on the basis of the total mass of the single fibers F. From the viewpoint of easily obtaining excellent spinnability, the total amount of the component (A) and the component (B) may be 50% by mass or more, more than 50% by mass, 60% by mass or more, 70% by mass or more, 80% by mass or more, 90% by mass or more, 92% by mass or more, 93% by mass or more, 94% by mass or more, or 95% by mass or more. From the viewpoint of easily obtaining excellent combability, the total amount of the component (A) and the component (B) may be less than 100% by mass, 99% by mass or less, 97% by mass or less, 95% by mass or less, 94% by mass or less, 93% by mass or less, or 92% by mass or less. From these viewpoints, the total amount of the component (A) and the component (B) may be 50% by mass or more and less than 100% by mass, more than 50% by mass and less than 100% by mass, 70 to 99% by mass, 80 to 99% by mass, or 90 to 99% by mass. The single fibers F each contain, as the component (C), a (meth)acrylic acid-based polymer. The “(meth)acrylic acid-based polymer” is a polymer having a (meth)acrylic acid-based compound (a compound having a (meth)acryloyl group) as a monomer unit (a polymer having a structural unit derived from a (meth)acrylic acid-based compound).

Examples of the (meth)acrylic acid-based compound include (meth)acrylic acid; and (meth)acrylic acid esters such as methyl (meth)acrylate, ethyl (meth)acrylate, propyl (meth)acrylate, butyl (meth)acrylate, and 2-ethylhexyl (meth)acrylate.

The component (C) may be a homopolymer of a (meth)acrylic acid-based compound, and may be a copolymer of a (meth)acrylic acid-based compound. The copolymer of the (meth)acrylic acid-based compound may be a copolymer having a plurality of kinds of (meth)acrylic acid-based compounds as monomer units, and may be a copolymer having a (meth)acrylic acid-based compound and a compound different from the (meth)acrylic acid-based compound as monomer units. From the viewpoint of easily obtaining excellent spinnability, combability, and voluminousness, the component (C) may include a copolymer of a (meth)acrylic acid-based compound, and may include a copolymer having a plurality of kinds of (meth)acrylic acid-based compounds as monomer units.

Examples of the compound different from the (meth)acrylic acid-based compound include vinyl chloride, the above-described aromatic vinyl compound (for example, a styrene-based compound such as styrene), and 2-ethylhexyl. Examples of the copolymer of the (meth)acrylic acid-based compound include a copolymer of (meth)acrylic acid ester and vinyl chloride, and a copolymer of (meth)acrylic acid ester and an aromatic vinyl compound (for example, a styrene-based compound such as styrene), and include a copolymer of butyl (meth)acrylate and vinyl chloride, a copolymer of (meth)acrylic acid, vinyl chloride, and 2-ethylhexyl, and a copolymer of methyl methacrylate, alkyl acrylate, and styrene.

From the viewpoint of easily obtaining excellent spinnability, combability, and voluminousness, the content of the monomer unit of the (meth)acrylic acid-based compound in the component (C) may be 50% by mass or more, more than 50% by mass, 60% by mass or more, 70% by mass or more, 80% by mass or more, 90% by mass or more, 92% by mass or more, 95% by mass or more, 96% by mass or more, 98% by mass or more, 99% by mass or more, 99.5% by mass or more, or substantially 100% by mass, on the basis of the entire component (C).

From the viewpoint of easily obtaining excellent spinnability, combability, and voluminousness, the component (C) may have (meth)acrylic acid ester as a monomer unit, and may have at least one selected from the group consisting of methyl (meth)acrylate and butyl (meth)acrylate as a monomer unit. That is, the component (C) may be an embodiment having methyl (meth)acrylate as a monomer unit, and may be an embodiment having butyl (meth)acrylate as a monomer unit.

From the viewpoint of easily obtaining excellent spinnability, combability, and voluminousness, the content of the monomer unit of the (meth)acrylic acid ester (the total amount of the monomer unit of the acrylic acid ester and the monomer unit of methacrylic acid ester; the same applies hereinafter) may be in the following range on the basis of the entire component (C) or the content of the monomer unit of the (meth)acrylic acid-based compound. The content of the monomer unit of the (meth)acrylic acid ester may be 50% by mass or more, more than 50% by mass, 55% by mass or more, more than 55% by mass, 60% by mass or more, more than 67% by mass, 70% by mass or more, 80% by mass or more, 90% by mass or more, more than 90% by mass, 92% by mass or more, 95% by mass or more, 96% by mass or more, 98% by mass or more, 99% by mass or more, 99.5% by mass or more, or substantially 100% by mass.

The content of the monomer unit of the methyl (meth)acrylate (the total amount of the monomer unit of methyl acrylate and the monomer unit of methyl methacrylate; the same applies hereinafter) may be in the following range on the basis of the entire component (C) or the content of the monomer unit of the (meth)acrylic acid-based compound. From the viewpoint of easily obtaining excellent combability, the content of the monomer unit of the methyl (meth)acrylate may be 30% by mass or more, 35% by mass or more, 40% by mass or more, 45% by mass or more, 50% by mass or more, more than 50% by mass, 55% by mass or more, 60% by mass or more, more than 60% by mass, 65% by mass or more, 70% by mass or more, more than 70% by mass, 75% by mass or more, 79% by mass or more, 80% by mass or more, 82% by mass or more, or 85% by mass or more. The content of the monomer unit of the methyl (meth)acrylate may be less than 100% by mass, 95% by mass or less, 90% by mass or less, 85% by mass or less, 82% by mass or less, 80% by mass or less, 79% by mass or less, 75% by mass or less, 70% by mass or less, less than 70% by mass, 65% by mass or less, 60% by mass or less, less than 60% by mass, 55% by mass or less, or 50% by mass or less. From these viewpoints, the content of the monomer unit of the methyl (meth)acrylate may be 30% by mass or more and less than 100% by mass, 40 to 95% by mass, 40 to 90% by mass, 50 to 90% by mass, 60 to 90% by mass, 70 to 90% by mass, 80 to 90% by mass, 50 to 85% by mass, 60 to 85% by mass, 70 to 85% by mass, or 80 to 85% by mass.

The content of the monomer unit of the butyl (meth)acrylate (the total amount of the monomer unit of butyl acrylate and the monomer unit of butyl methacrylate; the same applies hereinafter) may be in the following range on the basis of the entire component (C) or the content of the monomer unit of the (meth)acrylic acid-based compound. The content of the monomer unit of the butyl (meth)acrylate may be more than 0% by mass, 5% by mass or more, 10% by mass or more, 15% by mass or more, 18% by mass or more, 20% by mass or more, 21% by mass or more, 25% by mass or more, 30% by mass or more, more than 30% by mass, 35% by mass or more, 40% by mass or more, more than 40% by mass, 45% by mass or more, or 50% by mass or more. From the viewpoint of easily obtaining excellent combability, the content of the monomer unit of the butyl (meth)acrylate may be 70% by mass or less, 65% by mass or less, 60% by mass or less, 55% by mass or less, 50% by mass or less, less than 50% by mass, 45% by mass or less, 40% by mass or less, less than 40% by mass, 35% by mass or less, 30% by mass or less, less than 30% by mass, 25% by mass or less, 21% by mass or less, 20% by mass or less, 18% by mass or less, or 15% by mass or less. From these viewpoints, the content of the monomer unit of the butyl (meth)acrylate may be more than 0% by mass and 70% by mass or less, 5 to 60% by mass, 10 to 60% by mass, 10 to 50% by mass, 10 to 40% by mass, 10 to 30% by mass, 10 to 20% by mass, 15 to 50% by mass, 15 to 40% by mass, 15 to 30% by mass, or 15 to 20% by mass.

The combination of the content of the monomer unit of the methyl (meth)acrylate and the content of the monomer unit of the butyl (meth)acrylate is arbitrary, and each of the content of the monomer unit of the methyl (meth)acrylate and the content of the monomer unit of the butyl (meth)acrylate may be in each of the above ranges. For example, the component (C) may be an embodiment in which the content of the monomer unit of the methyl (meth)acrylate is 30% by mass or more and less than 100% by mass and the content of the monomer unit of the butyl (meth)acrylate is more than 0% by mass and 70% by mass or less, or an embodiment in which the content of the monomer unit of the methyl (meth)acrylate is 60 to 90% by mass and the content of the monomer unit of the butyl (meth)acrylate is 10 to 40% by mass, on the basis of the entire component (C) or the content of the monomer unit of the (meth)acrylic acid-based compound.

The component (C) may not have vinyl chloride as a monomer unit. The content of the monomer unit of the vinyl chloride may be 1% by mass or less, less than 1% by mass, 0.1% by mass or less, 0.01% by mass or less, or substantially 0% by mass, on the basis of the entire component (C).

The component (C) may not have (meth)acrylonitrile as a monomer unit, and may not have a vinyl cyanide compound as a monomer unit. The content of the monomer unit of the (meth)acrylonitrile or the content of the monomer unit of the vinyl cyanide compound may be 10% by mass or less, less than 10% by mass, 1% by mass or less, less than 1% by mass, 0.1% by mass or less, 0.01% by mass or less, or substantially 0% by mass, on the basis of the entire component (C).

The component (C) may not have a styrene-based compound as a monomer unit, and may not have an aromatic vinyl compound as a monomer unit. The content of the monomer unit of the styrene-based compound or the content of the monomer unit of the aromatic vinyl compound may be 30% by mass or less, 20% by mass or less, 10% by mass or less, less than 10% by mass, 1% by mass or less, less than 1% by mass, 0.1% by mass or less, 0.01% by mass or less, or substantially 0% by mass, on the basis of the entire component (C).

From the viewpoint of easily obtaining excellent combability, the weight average molecular weight of the component (C) may be 10000 or more, 50000 or more, 100000 or more, more than 100000, 150000 or more, 200000 or more, 300000 or more, more than 300000, 400000 or more, 500000 or more, 600000 or more, 700000 or more, 800000 or more, 900000 or more, 1000000 or more, 1200000 or more, 1500000 or more, 2000000 or more, 2500000 or more, 3000000 or more, 3500000 or more, 4000000 or more, 4500000 or more, 5000000 or more, 5500000 or more, 6000000 or more, 6500000 or more, 7000000 or more, 7500000 or more, 8000000 or more, or 8500000 or more. From the viewpoint of easily obtaining excellent spinnability, the weight average molecular weight of the component (C) may be 10000000 or less, 9500000 or less, 9000000 or less, or 8500000 or less. The weight average molecular weight of the component (C) may be 8000000 or less, 7500000 or less, 7000000 or less, 6500000 or less, 6000000 or less, 5500000 or less, 5000000 or less, 4500000 or less, 4000000 or less, 3500000 or less, 3000000 or less, 2500000 or less, 2000000 or less, 1500000 or less, 1000000 or less, 900000 or less, 800000 or less, 700000 or less, 600000 or less, 500000 or less, 400000 or less, or 300000 or less. From these viewpoints, the weight average molecular weight of the component (C) may be 10000 to 10000000, more than 100000 and 10000000 or less, 200000 to 10000000, 300000 to 10000000, more than 300000 and 10000000 or less, 500000 to 10000000, 700000 to 10000000, 1000000 to 10000000, 1500000 to 10000000, 3000000 to 10000000, 10000 to 8500000, 10000 to 6000000, 10000 to 4500000, 10000 to 4000000, 10000 to 3000000, 500000 to 8500000, 500000 to 5000000, 1000000 to 6000000, or 3000000 to 4500000.

The weight average molecular weight of the component (C) can be measured using gel permeation chromatography (GPC) under the following conditions. A calibration curve is prepared using standard polystyrene, and the weight average molecular weight can be expressed in terms of polystyrene.
Apparatus used: pump shodexDS-4 (manufactured by Showa Denko K.K.)
column shodex GPC HFIP-806M×3 (manufactured by Showa Denko K.K.)
detector HLC-8420GPC (manufactured by TOSOH CORPORATION)
Eluent: tetrahydrofuran (THF)
Pre-treatment: filtration using membrane filter (0.2 μm)
Concentration: 0.2 w/v %
Injection volume: 100 μL
Column temperature: 40° C.
Flow rate: 1.0 mL/min
Standard substance: polystyrene (PS)

The content of the component (C) is more than 0% by mass and 8% by mass or less on the basis of the total amount of the component (A) and the component (B). When the content of the component (C) is 8% by mass or less, excellent spinnability is obtained. It is presumed that, in the case of using the above-described specific amount of the component (C), since the mixing (compatibility) of the component (A) and the component (B) becomes favorable and the dispersibility of the component (A) and the component (B) is improved, discharge from a nozzle hole in spinning becomes uniform so that excellent spinnability is obtained. However, the factors that result in excellent spinnability are not limited to the above contents.

The content of the component (C) may be in the following range on the basis of the total amount of the component (A) and the component (B). From the viewpoint of easily obtaining excellent combability, the content of the component (C) may be 0.1% by mass or more, 0.2% by mass or more, 0.3% by mass or more, 0.5% by mass or more, 0.8% by mass or more, 1% by mass or more, 1.5% by mass or more, 2% by mass or more, 2.5% by mass or more, 3% by mass or more, 3.5% by mass or more, 4% by mass or more, 4.5% by mass or more, or 5% by mass or more. From the viewpoint of easily obtaining excellent spinnability, the content of the component (C) may be 7% by mass or less, 6.5% by mass or less, 6% by mass or less, 5.5% by mass or less, or 5% by mass or less. The content of the component (C) may be less than 5% by mass, 4.5% by mass or less, 4% by mass or less, 3.5% by mass or less, 3% by mass or less, 2.5% by mass or less, 2% by mass or less, 1.5% by mass or less, 1% by mass or less, 0.8% by mass or less, 0.5% by mass or less, or 0.3% by mass or less. From these viewpoints, the content of the component (C) may be 0.1 to 8% by mass, 0.1 to 5% by mass, 0.3 to 5% by mass, 0.5 to 5% by mass, 1 to 5% by mass, 0.3 to 4% by mass, 0.3 to 3% by mass, 0.3 to 2% by mass, 0.3 to 1% by mass, or 0.5 to 1.5% by mass.

In a case where the component (C) has methyl (meth)acrylate as a monomer unit, from the viewpoint of easily obtaining excellent spinnability and combability, the weight average molecular weight of the component (C) may be in each of the above ranges, and for example, the weight average molecular weight of the component (C) may be 500000 to 5000000. In a case where the component (C) has methyl (meth)acrylate as a monomer unit, from the viewpoint of easily obtaining excellent spinnability and combability, the content of the component (C) may be in each of the above ranges, and for example, the content of the component (C) may be 0.5 to 1.5% by mass on the basis of the total amount of the component (A) and the component (B).

The single fibers F each may contain a component other than the component (A), the component (B), and the component (C). Examples of such a component include polymers other than the component (A), the component (B), and the component (C) (polyolefin such as polypropylene; polyethylene terephthalate, and the like); an antistatic agent; a heat stabilizer; a lubricant; a processing aid, a plasticizer (for example, cyclohexanedicarboxylate-based plasticizer), a reinforcing agent, an ultraviolet absorber, an antioxidant, a filler, a flame retardant, a pigment, an initial coloration-improving agent, an electrical conductivity-imparting agent, and a perfume. The single fibers F may not contain at least one of such components, and may not contain at least one selected from the group consisting of polyolefin (such as polypropylene) and polyethylene terephthalate.

Examples of the antistatic agent include cationic, anionic, and amphoteric antistatic agents. The content of the antistatic agent may be 0.01 to 1% by mass on the basis of the total amount of the component (A) and the component (B).

The heat stabilizer can be used for adjusting thermal decomposition at the time of molding, long-run workability, the color tone of filament, or the like. Examples of the heat stabilizer include a Ca—Zn-based heat stabilizer, a hydrotalcite-based heat stabilizer, a tin-based heat stabilizer, an epoxy-based heat stabilizer, and a β-diketone-based heat stabilizer. The content of the heat stabilizer may be 0.1 to 5% by mass on the basis of the total amount of the component (A) and the component (B).

Examples of the Ca—Zn-based heat stabilizer include zinc stearate, calcium stearate, zinc 12-hydroxystearate, and calcium 12-hydroxystearate. Examples of the hydrotalcite-based heat stabilizer include a hydrotalcite compound. Examples of the hydrotalcite compound include a complex salt compound composed of magnesium and/or an alkali metal with aluminum; a complex salt compound composed of zinc, magnesium, and aluminum; and a compound obtained by dehydrating crystal water. Examples of the tin-based heat stabilizer include mercapto tin-based heat stabilizers such as dimethyltin mercapto, dimethyltin mercaptide, dibutyltin mercapto, dioctyltin mercapto, a dioctyltin mercapto polymer, and dioctyltin mercapto acetate; maleate tin-based heat stabilizers such as dimethyltin maleate, dibutyltin maleate, dioctyltin maleate, and a dioctyltin maleate polymer; and laurate tin-based heat stabilizers such as dimethyltin laurate, dibutyltin laurate, and dioctyltin laurate. Examples of the epoxy-based heat stabilizer include epoxidized soybean oil and epoxidized linseed oil. Examples of the β-diketone-based heat stabilizer include stearoyl benzoyl methane (SBM) and dibenzoyl methane (DBM).

The lubricant can be used for reducing friction with a metal surface of a processing machine and a friction between resins and enhancing flowability to adjust processability. Examples of the lubricant include a metal soap-based lubricant, a higher fatty acid-based lubricant, an ester-based lubricant, a higher alcohol-based lubricant, and a hydrocarbon-based lubricant. The content of the lubricant may be 0.2 to 5% by mass on the basis of the total amount of the component (A) and the component (B).

Examples of the metal soap-based lubricant include metal soaps (for example, stearate, laurate, palmitate, and oleate of Na, Mg, Al, Ca, Ba, and the like). Examples of the higher fatty acid-based lubricant include saturated fatty acids such as stearic acid, palmitic acid, myristic acid, lauric acid, and capric acid; unsaturated fatty acids such as oleic acid; and mixtures thereof. Examples of the ester-based lubricant include a pentaerythritol-based lubricant, a montanic acid wax-based lubricant, and a lubricant composed of an alcohol and a fatty acid. Examples of the pentaerythritol-based lubricant include monoesters, diesters, triesters, or tetraesters of a higher fatty acid with pentaerythritol or dipentaerythritol; and mixtures thereof. Examples of the montanic acid wax-based lubricant include esters of montanic acids with higher alcohols (such as stearyl alcohol, palmityl alcohol, myristyl alcohol, lauryl alcohol, and oleyl alcohol). Examples of the higher alcohol-based lubricant include stearyl alcohol, palmityl alcohol, myristyl alcohol, lauryl alcohol, and oleyl alcohol. Examples of the hydrocarbon-based lubricant include polyethylene wax and polypropylene wax.

The content of the cyclohexanedicarboxylate-based plasticizer in the single fibers F may be 1 part by mass or less, less than 1 part by mass, 0.1 parts by mass or less, 0.01 parts by mass or less, or substantially 0 parts by mass, with respect to 100 parts by mass of the component (A).

The content of a vinyl chloride-based acrylic graft copolymer in the single fibers F may be 1% by mass or less, less than 1% by mass, 0.1% by mass or less, 0.01% by mass or less, or substantially 0% by mass, on the basis of the total amount of the component (A) and the vinyl polymer.

The fiber for artificial hair of the present embodiment may further have single fibers different from the single fibers F in addition to the single fibers F, that is, may have the single fibers F and single fibers different from the single fibers F. The single fibers different from the single fibers F may be fibers containing two of the component (A), the component (B), and the component (C) but not containing the remaining one component, fibers containing one of the component (A), the component (B), and the component (C) but not containing the remaining two components, fibers not containing the component (A), the component (B), and the component (C), or the like. The single fibers different from the single fibers F may contain polyolefin such as polypropylene, polyethylene terephthalate, or the like.

A method for producing a fiber for artificial hair of the present embodiment includes a melt-spinning step of melt-spinning a resin composition containing the component (A), the component (B), and the component (C) to obtain a plurality of single fibers F. In the melt-spinning step, for example, the resin composition may be extruded for melt-spinning by using a metallic nozzle having a plurality of nozzle holes under the conditions of a cylinder temperature of 140 to 190° C. and a nozzle temperature of 180±15° C. In the extrusion, a single screw extruder, a counter-rotating twin screw extruder, a conical twin screw extruder, or the like may be used, and a single screw extruder having a bore diameter of 30 to 85 mmϕ or a conical extruder having a bore diameter of 30 to 50 mmϕ may be used.

The method for producing a fiber for artificial hair of the present embodiment may include a melt-kneading step of melt-kneading the component (A), the component (B), and the component (C) to obtain a resin composition, before the melt-spinning step. In the melt-kneading step, for example, the component (A), the component (B), and the component (C) may be stirred and mixed to obtain a powder compound, and then the powder compound may be melt-kneaded to obtain a pellet compound. When the component (A), the component (B), and the component (C) are stirred and mixed, an antistatic agent, a heat stabilizer, a lubricant, or the like may be mixed as appropriate. In the stirring and mixing for obtaining a powder compound, a Henschel mixer, a supermixer, a ribbon blender, or the like can be used. In the melt-kneading for obtaining a pellet compound, a single screw extruder, a counter-rotating twin screw extruder, a conical twin screw extruder, a corotating twin screw extruder, a cokneader, a planetary gear extruder, a roll kneader, or the like can be used.

The method for producing a fiber for artificial hair of the present embodiment may include a winding step of winding up the fiber obtained in the melt-spinning step, after the melt-spinning step. In the winding step, the fiber obtained in the melt-spinning step may be introduced into a heating cylinder (heating cylinder temperature: about 250° C.), instantaneously heat-treated, and then wound by a drawing machine.

The method for producing a fiber for artificial hair of the present embodiment may include a stretching step of subjecting the fiber (non-stretched fiber) to a stretching treatment, after the winding step. In the stretching step, for example, the non-stretched fiber may be stretched 2 to 4 times using a stretching machine (in an air atmosphere, 90 to 120° C.).

The method for producing a fiber for artificial hair of the present embodiment may include a heating step of subjecting the fiber to a heating treatment, after the stretching step. In the heating step, for example, the fiber may be heat-treated in an air atmosphere using a heat treatment machine until the fiber total length shrinks to 0.5 to 0.9 times the length before the treatment. The heating temperature in the heating step may be 80 to 120° C., 90 to 115° C., or 100 to 110° C.

A hair decoration product of the present embodiment has the fiber for artificial hair of the present embodiment. As the hair decoration product, wigs and the like are exemplified. The fiber for artificial hair in the hair decoration product of the present embodiment may be in any state before or after the gear processing treatment for crimping the fiber for artificial hair.

### EXAMPLES

Hereinafter, specific embodiments of the present invention will be described in more detail by means of Examples and Comparative Examples, but the present invention is not limited only to these Examples.

### <Production of Resin Composition>

A resin composition composed of a vinyl chloride polymer (a homopolymer of vinyl chloride, manufactured by TAIYO VINYL CORPORATION, trade name: TH-1000), an aromatic vinyl polymer of Table 1 or Table 2, a (meth)acrylic acid-based polymer of Table 1 or Table 2, 0.5 parts by mass of an antistatic agent (manufactured by NOF CORPORATION, trade name: NEW ELEGAN ASK), 3 parts by mass of a hydrotalcite-based complex salt compound (manufactured by Nissan Chemical Corporation, trade name: CP-410A), 0.5 parts by mass of epoxidized soybean oil (manufactured by Asahi Denka Co., Ltd., trade name: O-130P), and 0.8 parts by mass of an ester-based lubricant (manufactured by Riken Vitamin Co., Ltd., trade name: EW-100) was prepared. The amounts of the vinyl chloride polymer, the aromatic vinyl polymer, and the (meth)acrylic acid-based polymer used (total amount of the vinyl chloride polymer and the aromatic vinyl polymer: 100 parts by mass) are shown in Table 1 and Table 2.

As the aromatic vinyl polymer and the (meth)acrylic acid-based polymer, the following polymers were used.

### (Aromatic Vinyl Polymer)

B1: polymer having 68% by mass of a styrene monomer unit and 32% by mass of an acrylonitrile monomer unit (manufactured by Denka Company Limited, trade name: GR-AT-6S)
B2: polymer having 75% by mass of a styrene monomer unit and 25% by mass of an acrylonitrile monomer unit (manufactured by Denka Company Limited, trade name: GR-AT-5S)
B3: polymer having 82% by mass of a styrene monomer unit and 18% by mass of an acrylonitrile monomer unit (manufactured by Denka Company Limited, trade name: AS-C800)
B4: polymer having 86% by mass of a styrene monomer unit and 14% by mass of an acrylonitrile monomer unit (in-house preparation)
B5: polymer having 64% by mass of a styrene monomer unit and 36% by mass of an acrylonitrile monomer unit (in-house preparation)

### ((Meth)Acrylic Acid-Based Polymer)

C1: polymer having 85% by mass of a methyl methacrylate monomer unit and 15% by mass of butyl acrylate (Mitsubishi Chemical Group Corporation, trade name: METABLEN P-551A, weight average molecular weight: 1500000)
C2: polymer having 80% by mass of a methyl methacrylate monomer unit and 20% by mass and butyl acrylate (Mitsubishi Chemical Group Corporation, trade name: METABLEN P-530A, weight average molecular weight: 3000000)
C3: polymer having 79% by mass of a methyl methacrylate monomer unit and 21% by mass of butyl acrylate (Mitsubishi Chemical Group Corporation, trade name: METABLEN P-531A, weight average molecular weight: 4000000)
C4: polymer having 70% by mass of a methyl methacrylate monomer unit and 30% by mass of butyl acrylate (KANEKA CORPORATION, trade name: KaneAce PA-60, weight average molecular weight: 8500000)
C5: polymer having 70% by mass of a methyl methacrylate monomer unit and 30% by mass of butyl acrylate (KANEKA CORPORATION, trade name: KaneAce PA-40, weight average molecular weight: 6000000)
C6: polymer having 70% by mass of a methyl methacrylate monomer unit and 30% by mass of butyl acrylate (KANEKA CORPORATION, trade name: KaneAce PA-20, weight average molecular weight: 1000000)
C7: polymer having 50% by mass of a methyl methacrylate monomer unit and 50% by mass butyl acrylate (Mitsubishi Chemical Group Corporation, trade name: METABLEN P-501A, weight average molecular weight: 700000)
C8: polymer having 50% by mass of a methyl methacrylate monomer unit and 50% by mass of butyl acrylate (Mitsubishi Chemical Group Corporation, trade name: METABLEN P-570A, weight average molecular weight: 300000)
C9: copolymer of methyl methacrylate, alkyl acrylate, and styrene (Mitsubishi Chemical Group Corporation, trade name: METABLEN P-710, weight average molecular weight: 700000)
C10: copolymer of methyl methacrylate, alkyl acrylate, and styrene (Mitsubishi Chemical Group Corporation, trade name: METABLEN P-700A, weight average molecular weight: 500000)

### <Production of Fiber for Artificial Hair>

Compounding was performed using the above-described resin composition with an extruder having a diameter (bore diameter) of 40 mm at a cylinder temperature of 130 to 170° C. to produce a pellet. Next, the above-described pellet was melt-spun by an extruder having a diameter of 30 mm at an extrusion rate of 10 kg/hr at a cylinder temperature of 140 to 190° C. and at a nozzle temperature of 180° C. by using a nozzle having a nozzle cross-sectional area of 0.06 mm², having a round shape, and having the number of holes of 120. Thereafter, heat-treating was performed by a heating cylinder (250° C.) installed at a position of 4.5 m directly below the nozzle for 1.0 second, thereby obtaining Fiber A (non-stretched fiber) with 150 dtex. Next, Fiber A was stretched 3 times in an air atmosphere at 100° C. to obtain Fiber B. Subsequently, Fiber B was heat-treated in an air atmosphere at a heating temperature (annealing temperature) of 110° C. until the fiber total length shrunk to 0.75 times the length before the treatment, thereby obtaining a plurality of single fibers as a fiber for artificial hair. Note that, in Comparative Examples 1 and 2, spinnability was poor and single fibers could not be obtained.

### <Single Fiber Fineness of Single Fibers>

The length of the single fibers in the above-described fiber for artificial hair (excluding Comparative Examples 1 and 2) was adjusted to 900 mm, and then the mass of each of 100 single fibers was measured to determine the single fiber fineness (unit: dtex). Furthermore, the average value and standard deviation of the single fiber fineness were calculated, and the coefficient of variation was calculated by the following formula. The results are shown in Table 1 and Table 2.

$$Coefficient of variation [ \% ] = ( Standard deviation / Average value ) \times 100$$

### <Evaluation>

As for the above-described fibers for artificial hair, spinnability, combability (combing resistive force), and voluminousness (specific volume) were evaluated according to the following evaluation methods and criteria. The results are shown in Table 1 and Table 2, Combability and voluminousness were not evaluated in Comparative Examples 1 and 2.

### (Spinnability)

As for spinnability, the occurrence status of the yarn breakage per an hour during melt-spinning for obtaining Fiber A (non-stretched fiber) in the production of the above-described fiber for artificial hair was visually observed. The spinnability was evaluated according to the following criteria.
A: The yarn breakage was one time.
B: The yarn breakage was 2 to 3 times.
C: The yarn breakage was 4 times or more.

### (Combability)

The combability was evaluated by the following procedure. First, the fiber bundle of single fibers in the above-described fiber for artificial hair (the number of fibers: 12000, length: 10 m, mass: 800 g) was subjected to a gear processing treatment (treatment in the fiber length direction, depth of the groove of the gear waveform: 2.5 mm, gear pitch: 2.5 mm, surface temperature: 90° C., processing rate: 1.0 m/min) to obtain a fiber bundle of fibers for evaluation. This fiber bundle was adjusted to have a length of 300 mm and a mass of 20 g, and then the resistive force [unit: gf] when the fiber bundle was passed through a comb at a moving speed of 10 mm/sec and a moving distance of 100 mm was measured by a static/dynamic friction measuring machine (manufactured by TRINITY-LAB Inc., trade name “TL201Tt”). It was determined that the combability is favorable as the resistive force is smaller.

### (Voluminousness)

The voluminousness was evaluated by the following procedure. First, the fiber bundle of single fibers in the above-described fibers for artificial hair (the number of fibers: 12000, length: 10 m, mass: 800 g) was subjected to a gear processing treatment (treatment in the fiber length direction, depth of the groove of the gear waveform: 2.5 mm, gear pitch: 2.5 mm, surface temperature: 90° C., processing rate: 1.0 m/min) to obtain a fiber for evaluation, and then this fiber for evaluation was cut into a length of 100 mm to obtain fiber pieces. Next, without applying any load, the fiber pieces were filled in a 56 cc container (100 mm×14 mm×40 mm) until the container became full. The filled fiber pieces were taken out and then the mass of the fiber pieces was measured. Then, the specific volume was calculated by formula “Volume (cc) of the container/Mass (g) of the fiber pieces=Specific volume (cc/g)”. The value of the specific volume was calculated by performing round off to one decimal place.

TABLE 1

| | | Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Vinyl chloride polymer | | 75 | 75 | 75 | 75 | 75 | 75 | 75 | 75 | 75 | 75 | 75 | 75 | 75 |
| Aromatic vinyl | B1 | 25 | 25 | 25 | 25 | 25 | 25 | 25 | 25 | 25 | 25 | 25 | 25 | 25 |
| polymer | | | | | | | | | | | | | | |
| (Meth)acrylic | C1 | 1 | | | | | | | | | | 0.3 | 2 | 5 |
| acid-based | C2 | | 1 | | | | | | | | | | | |
| polymer | C3 | | | 1 | | | | | | | | | | |
| | C4 | | | | 1 | | | | | | | | | |
| | C5 | | | | | 1 | | | | | | | | |
| | C6 | | | | | | 1 | | | | | | | |
| | C7 | | | | | | | 1 | | | | | | |
| | C8 | | | | | | | | 1 | | | | | |
| | C9 | | | | | | | | | 1 | | | | |
| | C10 | | | | | | | | | | 1 | | | |
| Single fiber | Average value | 50 | 50 | 50 | 50 | 50 | 50 | 50 | 50 | 50 | 50 | 50 | 50 | 50 |
| fineness | Standard deviation | 5 | 5 | 5 | 5 | 5 | 7 | 8 | 9 | 12 | 15 | 10 | 5 | 5 |
| | Coefficient of | 10 | 10 | 10 | 10 | 10 | 14 | 16 | 18 | 24 | 30 | 20 | 10 | 10 |
| | variation | | | | | | | | | | | | | |
| Evaluation | Spinnability | A | A | A | B | B | A | A | A | A | A | A | B | B |
| | Combability [gf] | 200 | 200 | 200 | 190 | 200 | 210 | 220 | 230 | 240 | 250 | 250 | 200 | 190 |
| | Voluminousness | 8.5 | 8.5 | 8.5 | 8.5 | 8.5 | 8.5 | 8.5 | 8.5 | 8.5 | 8.5 | 8.5 | 8.5 | 8.5 |
| | [cc/g] | | | | | | | | | | | | | |

TABLE 2

| | | Example | | | | | | | Comparative Example | | |
|---|---|---|---|---|---|---|---|---|---|---|---|
| | | 14 | 15 | 16 | 17 | 18 | 19 | 20 | 1 | 2 | 3 |
| Vinyl chloride polymer | | 75 | 75 | 75 | 75 | 96 | 90 | 55 | 49 | 75 | 75 |
| Aromatic vinyl | B1 | | | | | 4 | 10 | 45 | 51 | 25 | 25 |
| polymer | B2 | 25 | | | | | | | | | |
| | B3 | | 25 | | | | | | | | |
| | B4 | | | 25 | | | | | | | |
| | B5 | | | | 25 | | | | | | |
| (Meth)acrylic acid- | C1 | 1 | 1 | 1 | 1 | 1 | 1 | 1 | 1 | 10 | 0.1 |
| based polymer | | | | | | | | | | | |
| Single fiber fineness | Average value | 50 | 50 | 50 | 50 | 50 | 50 | 50 | — | — | 50 |
| | Standard deviation | 5 | 5 | 5 | 5 | 15 | 6 | 5 | — | — | 20 |
| | Coefficient of | 10 | 10 | 10 | 10 | 30 | 12 | 10 | — | — | 40 |
| | variation | | | | | | | | | | |
| Evaluation | Spinnability | A | A | B | A | A | A | B | C | C | A |
| | Combability [gf] | 200 | 200 | 200 | 200 | 260 | 210 | 200 | — | — | 330 |
| | Voluminousness [cc/g] | 11.0 | 12.0 | 14.0 | 7.0 | 6.0 | 7.5 | 14.0 | — | — | 8.5 |

1. A fiber for artificial hair, comprising a plurality of single fibers,
wherein the single fibers each contain (A) a vinyl chloride polymer, (B) an aromatic vinyl polymer, and (C) a (meth)acrylic acid-based polymer,
a content of the component (B) is more than 0% by mass and 50% by mass or less on the basis of a total amount of the component (A) and the component (B),
a content of the component (C) is more than 0% by mass and 8% by mass or less on the basis of a total amount of the component (A) and the component (B), and
a coefficient of variation of fineness of the single fibers is 35 or less.

2. The fiber for artificial hair according to claim 1, wherein the component (B) has styrene and acrylonitrile as monomer units.

3. The fiber for artificial hair according to claim 1, wherein a weight average molecular weight of the component (C) is 200000 to 10000000.

4. The fiber for artificial hair according to claim 1, wherein the component (C) has methyl (meth)acrylate as a monomer unit.

5. The fiber for artificial hair according to claim 4, wherein in the component (C), a content of the monomer unit of methyl (meth)acrylate is 60 to 90% by mass, and a content of a monomer unit of butyl (meth)acrylate is 10 to 40% by mass.

6. The fiber for artificial hair according to claim 4, wherein a weight average molecular weight of the component (C) is 500000 to 5000000.

7. The fiber for artificial hair according to claim 4, wherein the content of the component (C) is 0.5 to 1.5% by mass on the basis of a total amount of the component (A) and the component (B).

8. A A hair decoration product comprising the fiber for artificial hair according to claim 1.

9. The fiber for artificial hair according to claim 1, wherein the component (C) includes a copolymer having a plurality of kinds of (meth)acrylic acid-based compounds as monomer units.

10. The fiber for artificial hair according to claim 1, wherein a content of a monomer unit of a (meth)acrylic acid-based compound is 60% by mass or more on the basis of the entire component (C).

11. The fiber for artificial hair according to claim 1, wherein the component (C) has (meth)acrylic acid ester as a monomer unit.

12. The fiber for artificial hair according to claim 11, wherein a content of the monomer unit of the (meth)acrylic acid ester is 60% by mass or more on the basis of the entire component (C).

13. The fiber for artificial hair according to claim 1, wherein the component (C) has at least one selected from the group consisting of methyl (meth)acrylate and butyl (meth)acrylate as a monomer unit.

14. The fiber for artificial hair according to claim 1, wherein the component (C) has butyl (meth)acrylate as a monomer unit.

15. The fiber for artificial hair according to claim 1, wherein the component (C) does not have vinyl chloride as a monomer unit.

16. The fiber for artificial hair according to claim 1, wherein a weight average molecular weight of the component (C) is 10000 to 10000000.
